(19) United States
(12) Patent Application Publication
(10) Pub. No.: US 2024/0185429 A1
(43) Pub. Date: Jun. 6, 2024

(54) LONG-RANGE OPTICAL DEVICE

(71) Applicant: Swarovski-Optik AG & Co KG., Absam (AT)

(72) Inventor: Harald MAIER, Absam (AT)

(21) Appl. No.: 18/529,780

(22) Filed: Dec. 5, 2023

(30) Foreign Application Priority Data
Dec. 6, 2022 (AT) A50929/2022

(51) Int. Cl. G06T 7/136; G06T 7/33; G06V 10/10; G06V 10/147; H04N 23/63; G06V 20/10

(52) U.S. Cl. CPC G06T 7/136; G06T 7/337; G06V 10/147; G06V 10/17; H04N 23/631; H04N 23/635; G06V 20/10

(57) ABSTRACT

A long-range optical device, in particular a binocular or monocular, a spotting scope, a telescope, a riflescope, a night-vision device or a rangefinder, wherein the long-range optical device is configured to compare at least one first image currently captured with the long-range optical device with at least one reference image previously captured with the long-range optical device for similarity and to calculate at least one degree for the similarity of the at least one currently captured image with the at least one reference image and, if the at least one degree of similarity reaches or exceeds or falls below at least one predetermined value, to output at least one indication for a user.

### RELATED APPLICATIONS

This application claims priority under 35 U.S.C. § 119(a)-(d) of Austrian Patent Application No. A50929/2022, filed Dec. 6, 2022, which is hereby incorporated by reference.

### TECHNICAL FIELD

The field of the present disclosure relates to a long-range optical device, in particular in the form of a binocular or a monocular, a spotting scope, a telescope, a riflescope, a night-vision device or a rangefinder.

### BACKGROUND

Long-range optical devices are optical instruments that make distant objects appear many times closer or larger to an observer, wherein the visual angle at which the distant object appears is enlarged by the long-range optical device compared to viewing with the naked eye, wherein a distance between the observer and the object is at least two meters. This applies both to devices with a direct view through the device (classic analog optical devices) and to electronic devices with a view onto a display (digital devices).

In various hunting applications, such as driven hunts, it may be necessary not to shoot in a certain region so as not to endanger other people. It is also relevant to observe territorial boundaries when hunting. However, in other applications it may also be desirable to make it easy to find a specific region viewed by a long-range optical device again, for example a landmark such as a mountain peak or another object such as an animal, even after the long-range optical device has been panned.

Shortcomings of the known solutions are that it is difficult for a user to recognize safety-critical regions or boundaries or to find objects that have already been viewed before.

A need remains for a long-range optical device that overcomes the above-mentioned shortcomings of the prior art.

### SUMMARY

A long-range optical device, such as a binocular, a monocular, a spotting scope, a telescope, a riflescope, a night-vision device or a rangefinder, is configured to compare at least one image currently captured with the long-range optical device with at least one reference image previously captured with the long-range optical device for similarity and to calculate at least one degree for the similarity of the at least one currently captured image with the at least one reference image and, if the at least one degree of similarity reaches or exceeds or falls below at least one predetermined value, to output at least one indication for a user.

According to an advantageous variant, it may be provided that the at least one indication is an optical and/or acoustic and/or haptic and/or mechanically and/or electromechanically generated indication.

Furthermore, in some embodiments the long-range optical device can be configured to compare the at least one currently captured image with at least two previously captured reference images that differ from one another for similarity and, if the at least one degree for the similarity of the at least one currently captured image with one of the two reference images exceeds or falls below the at least one predetermined value, to output the indication.

According to an advantageous advancement, it may be provided that a first reference image of the at least two reference images defines a first border of a region and a second reference image of the at least two reference images defines a second border of the region.

Preferably, the long-range optical device can be configured to determine whether the currently captured image is inside or outside the region.

In some embodiments, the long-range optical device can be configured to generate an indication of whether the at least one currently captured image is inside or outside the region.

The long-range optical device can have at least one electronic image capturing sensor, in particular in the form of a CCD and/or CMOS and/or infrared sensor, for example in the form of a microbolometer sensor.

According to a preferred embodiment, the long-range optical device can be configured to determine at least one first frequency distribution of values of at least one characteristic image parameter in the at least one reference image and at least one second frequency distribution of values of the at least one characteristic image parameter in the at least one currently captured image and to compare the two frequency distributions with one another.

Furthermore, the long-range optical device can be configured to calculate at least one correlation coefficient from the frequency distribution of the at least one reference image and the frequency distribution of the at least one currently captured image as a degree of the similarity of the at least one currently captured image with the at least one reference image.

According to an advantageous variant, the long-range optical device can be configured to calculate the at least one first frequency distribution and the at least one second frequency distribution each in the form of a histogram.

It has proven to be particularly advantageous that the at least one characteristic image parameter is a grayscale and/or color value of an individual pixel.

Furthermore, the long-range optical device can be configured to determine a grayscale image from the at least one reference image and from the at least one currently captured image.

The user-friendliness can be increased by the fact that the long-range optical device has at least one actuator device in order to trigger a capturing of the at least one reference image.

In a preferred variant, the long-range optical device can be configured to store the at least one reference image in an internal memory of the long-range optical device, in particular after input of a command for storing the at least one reference image.

According to an advantageous advancement, the long-range optical device can be configured to continuously capture currently captured images and compare them with the at least one reference image after inputting a command and/or executing an action, such as panning the long-range optical device.

Furthermore, it may be provided that the long-range optical device comprises at least one objective and at least one eyepiece.

Moreover, the long-range optical device may have an output unit for outputting the indication, in particular in the form of a display overlayed or arranged in at least one viewing channel of the long-range optical device or a simpler electro-optical display device such as an LCD segment display or an LED.

Furthermore, the long-range optical device can have at least one controller, in particular in the form of a processor, which is configured to calculate the degree of the similarity of the at least one currently captured image and the at least one reference image and to control the generation and output of the indication. Any electronic component, which can be programmed and can evaluate data, such as an FPGA (field-programmable gate array), an ASIC, a microcontroller, a microprocessor or a digital signal processor DSP etc., is to be understood as a processor.

For the purpose of better understanding of the present disclosure, it will be elucidated in more detail by means of the figures below in an exemplary manner.

### BRIEF DESCRIPTION OF THE DRAWINGS

For the purpose of better understanding of the invention, embodiments will be elucidated in more detail by means of the figures below in an exemplary manner.

These show in a respectively very simplified schematic representation:

FIG. 1 a block diagram of a telescope;

FIG. 2 a variant of a telescope;

FIG. 3 a further variant of a telescope in the form of a digital riflescope;

FIG. 4 a block diagram of components of the telescope of FIG. 1;

FIG. 5 frequency distributions of a reference image and a currently captured image;

FIG. 6 correlation coefficients of the reference image and currently captured images; and

FIG. 7 a region limited by two reference images.

### DETAILED DESCRIPTION OF PREFERRED EMBODIMENTS

First of all, it is to be noted that in the different embodiments described, equivalent parts are provided with the same or similar reference numbers and/or equivalent component designations, where the disclosures contained in the entire description may be analogously transferred to equivalent parts with equivalent reference numbers and/or equivalent component designations. Moreover, the specifications of location, such as at the top, at the bottom, at the side, chosen in the description refer to the directly described and depicted figure and in case of a change of position, these specifications of location are to be analogously transferred to the new position.

The embodiments are described across figures.

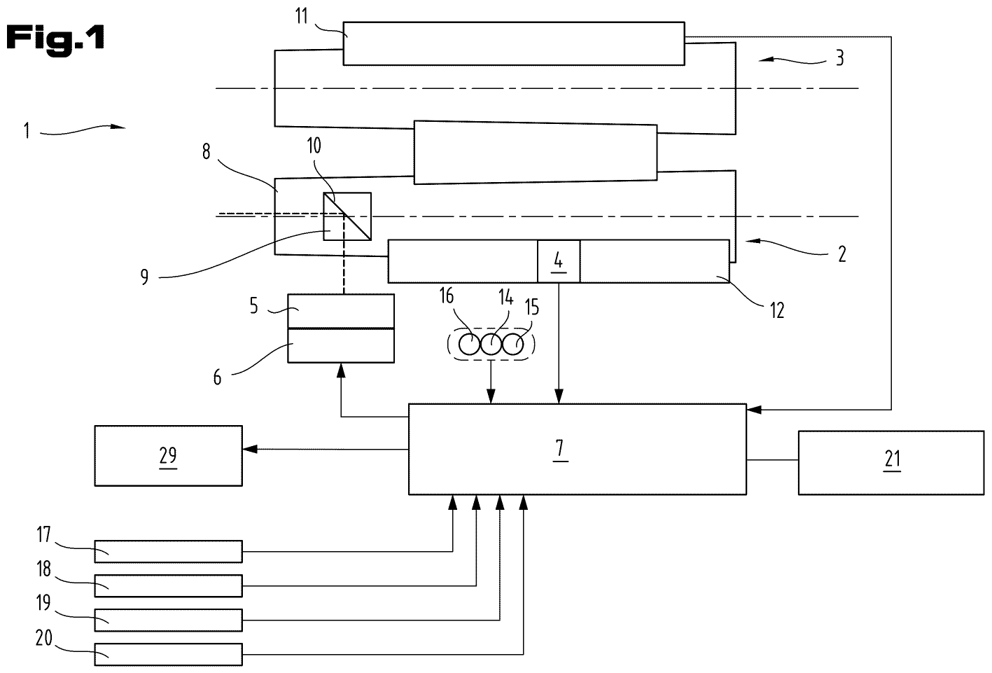

According to FIG. 1, a long-range optical device 1 in the form of a binocular or monocular, a spotting scope, a telescope, a riflescope, a night vision device or a rangefinder may comprise a viewing channel 2 or two viewing channels 2 and 3 as well as at least one image capturing sensor 4. It is particularly preferred for the image capturing sensor 4 to be part of a digital camera module and/or a digital camera. The image capturing sensor 4 can, for example, comprise a CCD sensor, a CMOS and/or infrared sensor, in particular in the form of a microbolometer sensor, or be formed as such.

According to one variant, the long-range optical device 1 can have a display 5 that is visible in the viewing channel 2, in particular is overlayed, particularly preferred reflected, in the one viewing channel 2. In the event that the long-range optical device 1 has two viewing channels 2, 3, it may be provided that a display is displayed in each of the viewing channels 2, 3. The display 5 is preferably an LCOS display (LCOS=Liquid Crystal on Silicon), an LCD or an LED matrix display.

The display 5 can be controlled by a controller 7 of the long-range optical device 1 via a display driver 6. The controller 7 is preferably a programmable circuit, for example in the form of a processor. The information shown on the display 5 can, for example, be reflected into the viewing channel 2.

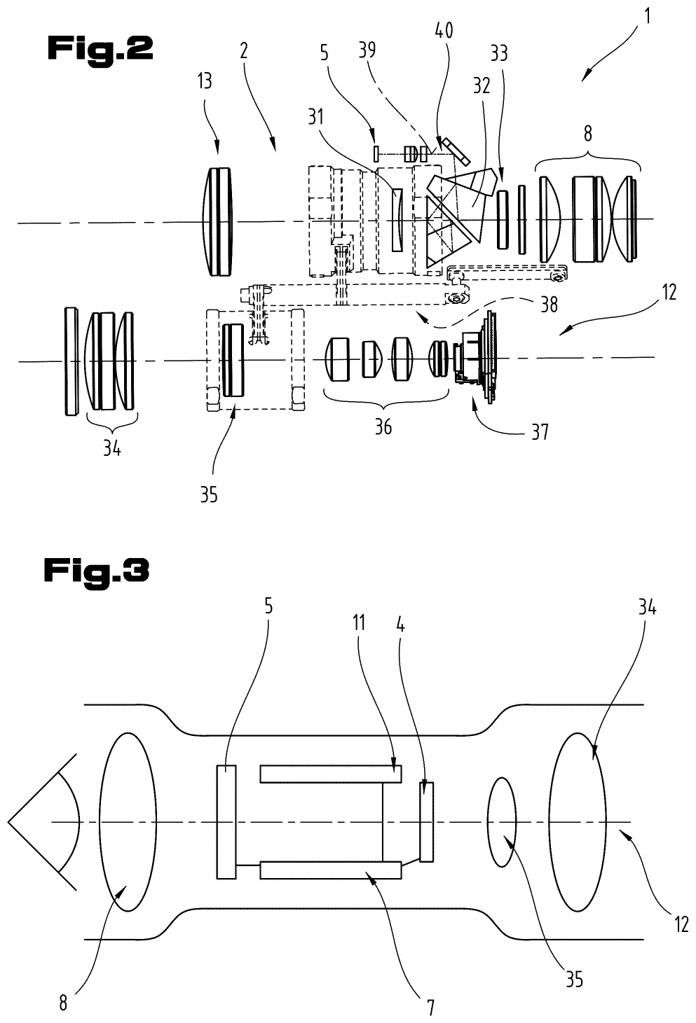

According to one possible embodiment, a user can see the overlay of an image of a distant object and a display generated by the display 5 when looking through an eyepiece 8 of the viewing channel 2. The display of the display 5 can enter a beam path of the viewing channel 2 via a display prism 9 and then into the eye of a user. In this case, the light rays coming from the display 5 can be deflected by 90° by reflection at a diagonally extending boundary surface 10 of the display prism 9 formed as a beam splitter cube, and thus be guided in the direction of the eyepiece 8 and into the beam path of the viewing channel 2, or coupled into the beam path via a partially transparent boundary surface of a prism of a prism erecting system 32 (FIG. 2).

For the energy supply, the long-range optical device 1 can have an energy storage 11, for example in the form of at least one rechargeable battery or battery pack or in the form of at least one accumulator.

For reasons of clarity, the optical components of the viewing channels 2, 3 and a camera channel 12 comprising the image capturing sensor 4 and/or the camera are not shown in further detail in FIG. 1.

FIG. 2 describes a possible nonlimiting further structure, while other structures than the one described are also possible. The viewing channel 2 can have an objective 13, a focusing lens 31, an erecting system 32 formed by prisms, a field lens 33 and an eyepiece 8. A first beam path for enlarged representation of a distant object can be formed in the viewing channel 2 by the mentioned optical elements. On the other hand, a second beam path can be formed with the camera channel 12, the optical elements of which can comprise an objective 34, a focusing lens 35, an eyepiece 36 and the image capturing sensor 4 and/or the camera or a camera module 37 according to an exemplary embodiment. The objective 34, the focusing lens 35 and the eyepiece 36 of the camera channel 12 may together form an afocal lens system. The camera module 37 and/or the camera can preferably be formed as a unit with the electronic image capturing sensor 4, a separate objective and with an integrated autofocus function. The viewing channel 2 and the camera channel 12 can be coupled to one another by means of an adjusting mechanism 38 such that a first image section viewed in the viewing channel 2 largely corresponds to a second image section captured by the camera module 37. If the long-range optical device 1 has a second viewing channel 3, it may have the same optical structure as the viewing channel 2.

Light rays 39 coming from the display 5 can be directed into the prism erecting system 32 via a display optics 40 and coupled into the beam path of the viewing channel 2 via a partially transparent boundary surface of a prism of the prism erecting system 32.

An eyepiece, objective, focusing lens or field lens can be a single lens, a cemented component consisting of two lenses or a collection of multiple lenses.

Even if the illustrated embodiment comprises at least one viewing channel 2, embodiments are also possible in which there is no direct viewing channel 2, 3 and instead only the camera channel 12 is present, as shown in FIG. 3 as a digital riflescope. The currently observed image and all additional information is output on a display 5 of the long-range optical device 1. The display 5 is arranged directly in the eyepiece 8 of the long-range optical device 1. An observer or user sees an object or objects currently being viewed with the long-range optical device 1 by looking through the eyepiece 8 onto the display 5, on which the currently captured image is shown, wherein the eyepiece 8 can also make the display 5 appear enlarged. In the variant shown in FIG. 3, the camera channel 12 can also have a focusing lens 35 as well as an energy storage 11 and a controller 7.

It should also be noted that if only the camera channel 12 is present, further optical components can be arranged in the camera channel 12, such as adjustable magnification optics, in particular comprising lenses, etc. In this way, for example, a riflescope, telescope, monocular or spotting scope with an optical zoom function can be easily realized even if only the camera channel 12 is used.

Even if a viewing channel 2 or two viewing channels 2, 3 are present, an observed object can alternatively or additionally be shown on a display that is not arranged in a viewing channel 2, 3 but on the outside of the long-range optical device 1.

According to a further embodiment, at least one viewing channel 2, 3 and the camera channel 12 may, alternatively or in addition to the above-mentioned embodiments, partially coincide. Here, for example, part of a light beam incident via the viewing channel 2, 3 can be decoupled from the viewing channel 2, 3, for example by means of a beam splitter, and directed to the image capturing sensor 4 and/or to the camera or camera module for image capturing.

One or more electronic operating elements 14, 15, 16, for example operating buttons, may be provided for performing actions, for example confirming entries, scrolling forwards and backwards in a menu shown on the display 5, etc.

Furthermore, the long-range optical device may comprise multiple sensors 17, 18, 19, 20, such as a geoposition acquisition sensor 17, in particular a GPS, GLONASS, Galileo or BeiDou receiver. Furthermore, it has proven to be particularly advantageous if the long-range optical device also has a brightness sensor 18, an electronic compass 19, an inclinometer and/or a gyro sensor 20, for example a gyroscope.

Moreover, the long-range optical device 1 may have one or multiple memories 21 which can be accessed by the controller 7. For example, images may be stored in a sub-area of this memory 21, while application programs may be stored in other sub-areas, which may be loaded into a working memory of the controller 7 as required. Also, sub-areas of the memory 21 may contain data recorded by the sensors 17, 18, 19, 20.

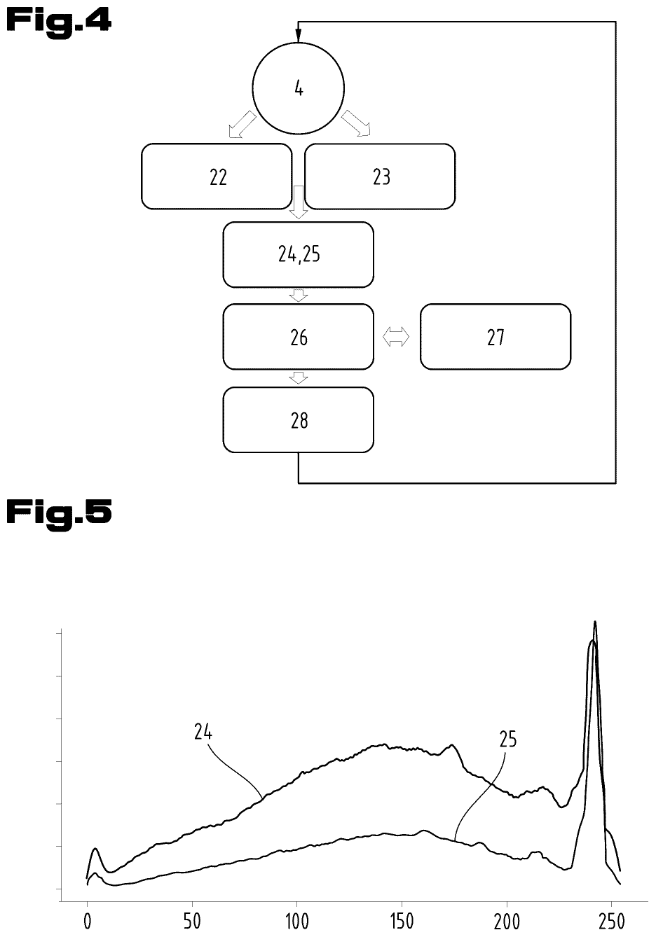

The long-range optical device 1 is configured to compare a reference image 22 captured with the long-range optical device 1 with a currently captured image 23 for similarity and to calculate at least one degree for the similarity of the currently captured image 23 with the reference image 22, as shown in FIG. 4.

The following sequence and/or method is provided in this regard (FIG. 4):
1. capturing of one (or more) reference image 22 with the camera 4;
2. (continuous) capturing of current images 23 with the camera 4;
3. converting the images 22, 23 into grayscale images (this step is omitted for monochrome images such as infrared images);
4. determining the histograms 24, 25 of the reference image 22 and the currently captured images 23;
5. to improve the subsequent correlation calculation, it can be helpful in an intermediate step to normalize and/or smooth the histograms previously determined in step 3;
6. calculating the correlation coefficient 26 between histogram 24 of the reference image 22 and histogram 25 of the current image 23;
7. comparing the correlation coefficient 26 with a limit value 27;
8. outputting an indication 28 on the display 5 if the correlation coefficient 26 is greater or less than the limit value 27; and
9. repeating the process from step 2.

The image sensor 4 and/or the camera and/or the camera module 37 can be used to capture the reference image 22. Capturing can take place, for example, when one of the operating elements 14, 15, 16 is actuated. The captured reference image 22 can be stored in the memory 21. The long-range optical device 1 can, for example, be configured to store the reference image 22 in the internal memory 21 of the long-range optical device 1 after a command has been entered, for example by actuating one of the operating elements 14, 15, 16.

The current image 23 can also be captured by means of the image sensor 4. The comparison of the current image 23 with the stored reference image 22 can be carried out by the controller 7. The continuous capturing of the current image 23 and the comparison with the reference image 22 can also be triggered after entering a command and/or executing an action, such as panning the long-range optical device 1 or actuating one of the operating elements 14, 15, 16.

As can be seen from FIGS. 4 and 5, the long-range optical device 1 and/or the controller 7 can be configured to determine a first frequency distribution 24 of values of at least one characteristic image parameter in the reference image 22 and a second frequency distribution 25 of values of the at least one characteristic image parameter in the currently captured image 23 and to compare the two frequency distributions 24 and 25 with each other. The long-range optical device 1 can further be configured to calculate a correlation coefficient 26 from the currently captured image 23 and the reference image 22 as a degree of the similarity of these images. The correlation coefficient 26 can be determined from the frequency distributions 24 and 25 in a manner known per se.

The comparison of the currently captured image 23 and the reference image 22 can be carried out continuously. For example, during a pan movement of the long-range optical device 1, it can be constantly checked whether the image 23 captured in a current angular position corresponds to the stored reference image 22. It goes without saying that even if individual images are compared for similarity, a large number of currently captured images 21 are compared with the stored image 22 in this regard.

At this point, it should be noted that in the present context, a match between the currently captured image 23 and the stored image 22 means that the degree of similarity of the two images 22, 23 reaches or exceeds the predetermined value 27.

Grayscale and/or color values of the images and/or grayscale and/or color values of the individual pixels of the images 22, 23 can be used as characteristic image parameters. A frequency distribution 24, 25, for example in the form of a histogram of the gray levels (brightness values, intensity values) and/or color value distribution, can be generated for the currently captured image 23 and the reference image 22. Histograms are thus understood to be a list of the frequency with which a certain brightness value of an image (for 8-bit grayscale images this is 256 intensity levels, for 8-bit color images 256 levels per color) occurs in the overall image (graphical representation in FIG. 5). The integral over the distribution function of all possible color values and/or grayscale values of the image 22, 23 results in the total number of pixels in the image 22, 23. For color images in an RGB color space, a grayscale image can be determined, for example, from the simple mean value of the individual color components ((R+G+B)/3) or according to the luminance method using a weighted sum (gray value =luminance y=0.3×R+0.59×B+0.11×B) or, for simplification, only individual color channels (R or G or B) can be used as the basis for the histogram. If an HSV color space is present, either the color value H (Hue) or the color saturation S (Saturation) or the brightness value V (Value) can be used as the grayscale image.

If there are images that do not have the full range of all possible brightness values (for example, with 8-bit images, the minimum brightness value may be greater than 0 and/or the maximum less than 255), histogram normalization can be helpful. The darkest pixel Iₘᵢₙ is mapped to 0 (I_{min′}) and the brightest (Iₘₐₓ) to the highest possible brightness value ((I_{max′}, 255 for 8-bit images) and all the values in between are distributed linearly. By stretching the X-axis in this way, the entire available value range of the histogram is optimally utilized. In this regard, the new brightness values I′ are calculated from the current brightness values I as follows:

$$\\ {I}^{{}_{} ′} = ( {I}_{max ′} - {I}_{min ′} ) \frac{I - {I}_{min}}{{I}_{max} - {I}_{min}} + {I}_{min ′}$$

In the event that I_{min′}=0 and I_{max′}=255, this formula is simplified to:

$$\\ {I}^{{}_{} ′} = 255 \frac{I - {I}_{min}}{{I}_{max} - {I}_{min}}$$

It can also be helpful to smooth the histograms before calculating the correlation coefficient. In this regard, smoothing is carried out by applying well-known filters, such as a Savitzky-Golay filter, which will not be discussed in further detail here. If the correlation coefficient 26, i.e., the degree of similarity of the two frequency distributions 24, 25, reaches or exceeds a predetermined value 27 or falls below it, the long-range optical device 1 is configured to output an indication 28 for a user.

FIG. 5 shows an example of a frequency distribution 24 (histogram) of gray values of the reference image 22 and a frequency distribution 25 of the gray values of the currently captured image 23. The color value and/or gray value is plotted on the ordinate axis and the number or relative proportion of pixels and/or pixels is plotted on the abscissa axis.

In FIG. 6, each point corresponds to a correlation coefficient 26 between a currently captured image 23 from a series of continuously captured current images 23 and the reference image 22. Thus, each point in FIG. 6 corresponds to a correlation coefficient 26 which is continuously determined from the frequency distributions 24 and 25 of a currently captured image 23 and the reference image 22. The correlation coefficients 26 are plotted on the ordinate axis and the individual currently captured images 23 are plotted on the abscissa axis, which corresponds to a time axis at a constant frame rate.

As is well known from classical statistics, the correlation coefficient describes how strongly two variables correlate with each other, i.e., how they are (linearly) related and therefore how similar they are to each other. The correlation coefficient R can take on values between −1 and +1, wherein R=0 means that there is no correlation. The closer R is to −1 (negative correlation) or +1 (positive correlation), the stronger the relationship between the two variables and the more similar they are. The similarity of two images can therefore be calculated by calculating the correlation coefficient R from the correlation of the associated histograms H:

$$\\ {R}_{22 , 23} = \frac{\sum [ ( {H}_{22 , i} - {\overline{H}}_{22} ) ( {H}_{23 , i} - {\overline{H}}_{23} ) ]}{\sqrt{\sum {( {H}_{22 , i} - {\overline{H}}_{22} )}^{2} \times \sum {( {H}_{22 , i} - {\overline{H}}_{22} )}^{2}}}$$

Wherein:
R_{22,23} . . . correlation coefficient between the histogram of the reference image 22 and the histogram of the current image 23;
H_{22,i} . . . i-th element of the histogram of the reference image 22;
H_{23,i} . . . i-th element of the histogram of the current image 23;
H̅₂₂ . . . average value of the histogram of the reference image 22;
H̅₂₃ . . . average value of the histogram of the current image 23.

The controller 7 can generate a corresponding signal when the currently captured image 23 and the reference image 22 match, which is then converted into an indication that can be perceived by a user. The indication can be an optical and/or acoustic and/or haptic and/or mechanically and/or electromechanically generated indication.

In the case of a visual indication, the indication can be shown on the display 5. For example, if the images 22 and 23 match, a colored frame can be displayed around the display 5 currently shown or visible in the viewing channel 2.

Alternatively or additionally, as long as there is no match between the currently captured image 22 and the image 22 stored as a reference, a frame in a first color, for example red, can be shown on the display 5 around the currently captured image 22, and as soon as the currently captured image 23 matches the stored image 22, a frame in a different color, for example green, or another visual indication can be shown.

As an alternative or in addition to the visual output of the indication 28, a haptic or acoustic output of the indication 28 can also be provided. To generate such an indication 28, the controller 7, according to FIG. 1, can be connected to an indication generator 29, for example a mechanical and/or electromechanical indication generator. The indication generator 29 can, for example, comprise a speaker and emit an acoustic signal, for example in the form of a whistling sound, in the event of a match between the currently detected image 23 and the reference image 22. Alternatively or additionally, the indication generator 29 may comprise a vibration mechanism that generates a vibration perceptible to the user in the event of a match between the currently captured image 23 and the reference image 22. It would also be conceivable that the indication generator 29 comprises a rotational mass whose rotational state is changed in the event of a match between the currently captured image 23 and the reference image 22 and generates a perceptible change in a tilting and/or twisting and/or panning resistance of the long-range optical device 1. For example, if the currently captured image 23 and the reference image 22 do not match, the rotating mass can remain in a resting state and, if the currently captured image 23 matches the reference image 22, it can be set in rotation by means of a drive actuated by the controller 7.

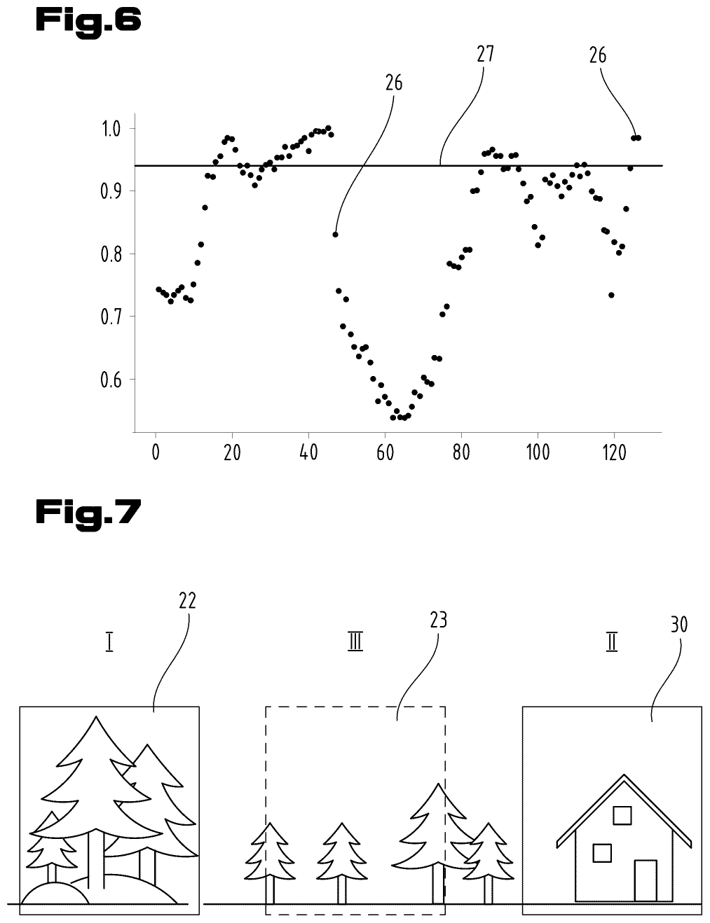

According to FIG. 7, it may be provided that the currently captured image 23 is compared with two previously captured reference images 22, 30 for similarity or correspondence. The comparison between the currently captured image 23 and the two reference images 22, 30 is carried out in the same way as a comparison with only one reference image 22, merely with the difference that two similarity comparisons are carried out. This means that each currently captured image 23 is compared with both reference images 22, 30.

If the degree of similarity of the currently captured image 23 with one of the two reference images 22, 30 exceeds the predetermined value 27, the indication 28 is output as in the previous embodiments. The indication 28 is output and generated in the same way as in the case of only one reference image 22. This advancement makes it possible to define a region III lying between the two reference images 22, 30, wherein the limits of the region III in each case correspond to a reference image 22, 30. This entails the advantage that, for example, a region III lying between the reference images 22, 30 can be defined as a “safe” region within which a shooter can fire a shot without danger to third parties. This can be particularly important for driven hunts where drivers are also used.

In FIG. 7, the left region border I corresponds to the first reference image 22 and the right region border II corresponds to the second reference image 30. The region III in between represents the “safe” region. In this context, when capturing the current captured image 23, the direction of movement (pan direction) about which the long-range optical device 1 is panned is also recorded in order to be able to determine whether the pan direction is from region I into region III or out of region III into region I if there is a similarity with the reference image 22, or from region II into region III or out of region III into region II if there is a similarity with the reference image 30.

The pan direction can be determined when a region border 22, 30 is crossed by continuously evaluating the change in the orientation determined by the compass 19 and/or by the signed rotation rate determined by the gyroscope 20.

When panning beyond the region borders I, II defined by the two stored images 22, 30, the indication for the user can be generated continuously and/or until the user pans the long-range optical device 1 such that an optical axis of the long-range optical device 1 again points into the region III lying between the two region borders I, II. Since the direction of the pan movement is known when leaving region III and/or when crossing the borders I or II, the user can also be shown the direction in which they must pan back in order to return to region III. Alternatively or additionally, the user can be shown that they are in the permitted region III with their current viewing direction defined by the orientation of the long-range optical device 1. For example, as long as the user is observing the permitted region, a corresponding visual indication can be shown on the display 5.

It will be obvious to those having skill in the art that many changes may be made to the details of the above-described embodiments without departing from the underlying principles of the invention. The scope of the present invention should, therefore, be determined only by the following claims.

What is claimed is:

1. A long-range optical device configured to compare at least one image currently captured with the long-range optical device with at least one reference image previously captured with the long-range optical device for similarity and to calculate at least one degree for the similarity of the at least one currently captured image with the at least one reference image and, if the at least one degree of similarity reaches or exceeds or falls below at least one predetermined value, to output at least one indication for a user.

2. The long-range optical device according to claim 1, wherein the at least one indication is an optical and/or acoustic and/or haptic and/or mechanically and/or electromechanically generated indication.

3. The long-range optical device according to claim 1, wherein it is configured to compare the at least one currently captured image with at least two previously captured reference images for similarity and, if the at least one degree for the similarity of the at least one currently captured image with one of the two reference images exceeds or falls below the at least one predetermined value, to output the indication.

4. The long-range optical device according to claim 3, wherein a first reference image of the at least two reference images defines a first border of a region and a second reference image of the at least two reference images defines a second border of the region.

5. The long-range optical device according to claim 4, wherein it is configured to determine whether the currently captured image is inside or outside the region.

6. The long-range optical device according to claim 5, wherein it is configured to generate an indication of whether the at least one currently captured image is inside or outside the region.

7. The long-range optical device according to claim 1, wherein it comprises at least one electronic image capturing sensor in the form of a CCD and/or CMOS and/or infrared sensor.

8. The long-range optical device according to claim 1, wherein the long-range optical device is configured to determine at least one first frequency distribution of values of at least one characteristic image parameter in the at least one reference image and at least one second frequency distribution of values of the at least one characteristic image parameter in the at least one currently captured image and to compare the two frequency distributions with one another.

9. The long-range optical device according to claim 1, wherein it is configured to calculate at least one correlation coefficient from the frequency distribution of the at least one reference image and the frequency distribution of the at least one currently captured image as a degree of the similarity of the at least one reference image with the at least one currently captured image.

10. The long-range optical device according to claim 8, wherein the long-range optical device is configured to calculate the at least one first frequency distribution and the at least one second frequency distribution each in the form of a histogram.

11. The long-range optical device according to claim 8, wherein the at least one characteristic image parameter is a grayscale and/or color value of an individual pixel.

12. The long-range optical device according to claim 1, wherein the long-range optical device is configured to determine a grayscale image from the at least one reference image and from the at least one currently captured image.

13. The long-range optical device according to claim 1, wherein it comprises at least one actuator device to trigger a capturing of the at least one reference image.

14. The long-range optical device according to claim 13, wherein it is configured to store the at least one reference image in an internal memory of the long-range optical device after input of a command for storing the at least one reference image.

15. The long-range optical device according to claim 1, wherein it is configured to continuously capture currently captured images and compare them with the at least one reference image after inputting a command and/or executing an action, such as panning the long-range optical device.

16. The long-range optical device according to claim 1, wherein it comprises at least objective and at least one eyepiece.

17. The long-range optical device according to claim 1, wherein it comprises an electro-optical display device visible through the eyepiece and operable to output the indication.

18. The long-range optical device according to claim 1, wherein it comprises at least one controller which is configured to calculate the degree of the similarity of the at least one currently captured image and the at least one reference image and to control the generation and output of the indication.
